(19) United States
(12) Patent Application Publication
(10) Pub. No.: US 2006/0080134 A1
(43) Pub. Date: Apr. 13, 2006

(54) Virtual system for accessing services for job seekers, employers, training providers, benefit applicants and others

(76) Inventor: Paul Toomey, Palm Harbor, FL (US)

Correspondence Address: LARSON AND LARSON, 11199 69TH STREET NORTH, LARGO, FL, 33773, US

(21) Appl. No.: 11/287,660

(22) Filed: Nov. 28, 2005

Related U.S. Application Data
(63) Continuation-in-part of application No. 09/899,325, filed on Jul. 5, 2001.
(60) Provisional application No. 60/216,809, filed on Jul. 7, 2000.

(51) Int. Cl. G06Q 99/00

(52) U.S. Cl. 705/1

(57) ABSTRACT

A computerized information system of workforce development services having a server having services for job seekers, staff, employers and training providers; a database of stored procedures coupled to the server; and input/output clients also coupled to the server for accessing information from a standardized database as well as additional information from other providers.

### RELATED APPLICATION

This application is a continuation-in-part of co-pending application Ser. No. 09/899,325 filed 07/05/2001 which is a continuation-in-part of co-pending Provisional Application Ser. No. 60/216,809 filed 7/7/00.

### BACKGROUND OF THE INVENTION

1. Field of the Invention

The present invention relates to a computerized information system for accessing workforce development services and more particularly pertains to providing job seekers, employers, training providers, benefit applicants, students, and the like with one-stop universal access to self-service and staff-assisted employment, training, labor market, education, community services, and reports.

2. Description of the Prior Art

The ability to use the Internet or to use computers on a network to search databases for jobs, or to receive training or counseling are known in the art. However, no single method or system currently provides a virtual one-stop site that provides access to a comprehensive array of services for job seekers, employers, training providers, benefit applicants, students, and other one-stop customers in one location, via the Internet or on a computer.

The present invention provides a system that facilitates compliance with The Workforce Investment Act (WIA) of Aug. 7, 1998. Pre-existing systems fulfill the minimum requirements of programs such as Welfare to Work and Wagner-Peyser, and provide services for adults, dislocated workers, youth, and employers. These features are organized and administered as core services and intensive/staff-assisted services of the present invention.

Labor market information by the U.S. Department of Labor's Employment and Training Administration is stored in the ALMIS database structure. Systems to access this standard database structure are known in the art.

The present invention complies with the America's Labor Market Information System (ALMIS) database structure for all applicable information. As such the system is able to share labor and economic data available from federal, state, and local agencies throughout the United States.

While these devices fulfill their respective, particular objectives and requirements, the aforementioned patents do not describe a computerized information system for accessing workforce development services that provide job seekers, employers, training providers, benefit applicants, students, and the like with one-stop universal access to self-service and staff-assisted employment, training, education, community services, and reports.

In this respect, the computerized information system for accessing workforce development services according to the present invention substantially departs from the conventional concepts and designs of the prior art, and in doing so provides an apparatus primarily developed for the purpose of providing job seekers, employers, training providers, benefit applicants, students, and the like with one-stop universal access to self-service and staff-assisted employment, training, labor market, education, community services, and reports.

Therefore, it can be appreciated that there exists a continuing need for a new and improved computerized information system for accessing workforce development services which can be used by job seekers, employers training providers, benefit applicants, students, and the like for one-stop universal access to self-service and staff-assisted employment, training, labor market, education, community services, and reports. In this regard, the present invention substantially fulfills this need.

### SUMMARY OF THE INVENTION

In view of the foregoing disadvantages inherent in the known types of existing methods of accessing workforce development services, the present invention provides an improved computerized information system for accessing workforce development services. As such, the general purpose of the present invention, which will be described subsequently in greater detail, is to provide a new and improved computerized information system for accessing workforce development services and method which has all the advantages of pre-existing methods and none of the disadvantages.

To attain this, the present invention essentially comprises a computerized information system for accessing workforce development services by job seekers, employers, training providers, benefit applicants, students, and the like, and allowing staff to manage and administer the system, providing job seekers, employers, training providers, benefit applicants, students, and the like with one-stop universal access to self-service and staff-assisted employment, training, labor market, education, community services, and reports, the system comprising in combination: a server having a plurality of core services including job seeker services, intensive and staff assisted services, and employer services, the job seeker services including a plurality of software components providing registration, online orientation and help, labor market services, preparation services, skills matching, social services and benefits information, self directed services, link to job banks, financial services, resume and cover letter builder, consumer reports, resource tracking, appointment calendar, staff and employer messaging, online file folder management, the intensive and staff assisted services including a plurality of software components providing registration, common intake, case management, full eligibility application, case notes, job seeker employment plan, enrollment tracking, program outcome tracking, follow-up tracking, welfare-to-work, self directed core service tracking, finance and grant tracking, appointment calendar, user messaging, job seeker online file folder management, user maintenance, system management and maintenance, the employer services including a plurality of software components providing registration, online job order management, online resume review, resume search by specific criteria, staff and job seeker messaging, employment incentives, references and resources, regional economic information, and industry and labor profiles. The server also having a plurality of additional services including training provider services and reporting services, the training provider services having a plurality of software components including registration, program information management, program completer details management, program approval request submission, individual training account status review, the reporting services having a plurality of software components including comprehensive reporting, Workforce Investment Act performance monitoring, and usage tracking. A database running stored procedures operatively coupled with the server for the two-way communication of information between the database and the server. A plurality of input/output client devices operatively coupled with the server for the two-way communication of information between the server and the client, the plurality of devices allowing access from job seekers, staff, employers, and training providers giving job seekers, training providers, benefit applicants, students, and the like universal access to self-service and staff-assisted employment, training, labor market, community services, and reports.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved computerized information system for accessing—workforce development services which has all of the advantages of pre-existing methods of accessing workforce development services and none of the disadvantages.

It is another object of the present invention to provide a new and improved computerized information system for accessing workforce development services which may be easily and efficiently manufactured and marketed.

It is further object of the present invention to provide a new and improved computerized information system for accessing workforce development services which is of durable and reliable constructions.

An even further object of the present invention is to provide a new and improved computerized information system for accessing workforce development services which is susceptible of a low cost of manufacture with regard to both materials and labor, and which accordingly is then susceptible of low prices of sale to the consuming public, thereby making such computerized information system for accessing workforce development services economically available to the buying public.

Even still another object of the present invention is to provide a computerized information system for accessing workforce development services that provides job seekers, employers, training providers, benefit applicants, students, and the like with one-stop universal access to self-service and staff-assisted employment, training, labor market, education, community services, and reports.

Lastly, it is an object of the present invention to provide a new and improved computerized information system of workforce development services comprising a server having a plurality of core services for job seekers, staff, employers, and training providers and a database of stored procedures and a plurality of input/output client devices.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is the system architecture of the computerized information system for accessing workforce development services.

FIG. 2 is a more detailed view of the system architecture showing the client, server, and database.

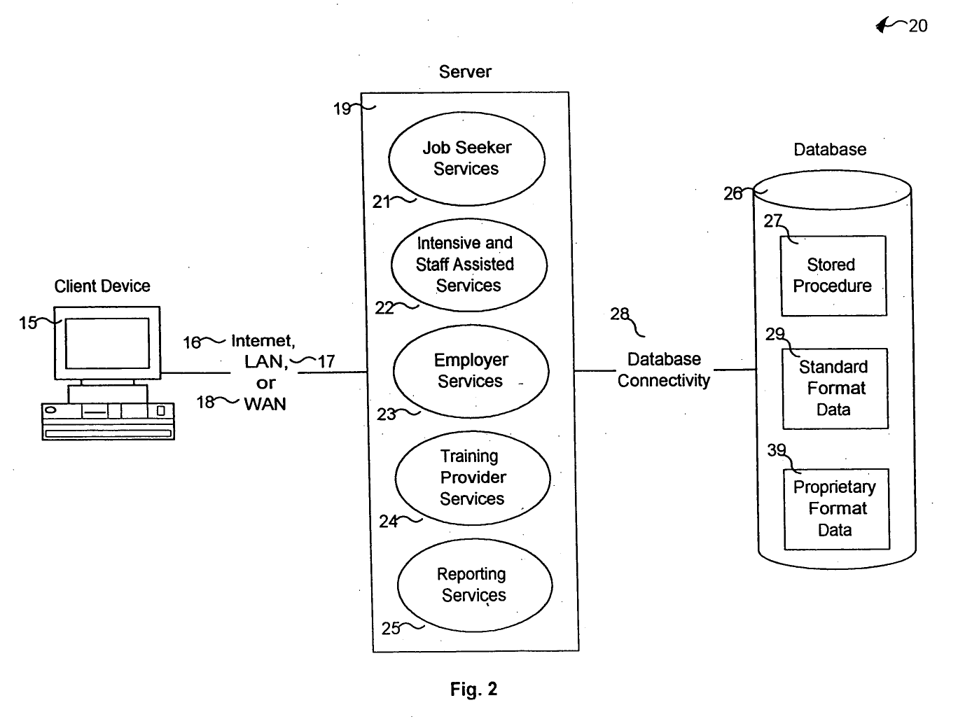

FIG. 3 is the server software comprising core services and a plurality of components including job seeker services and employer services.

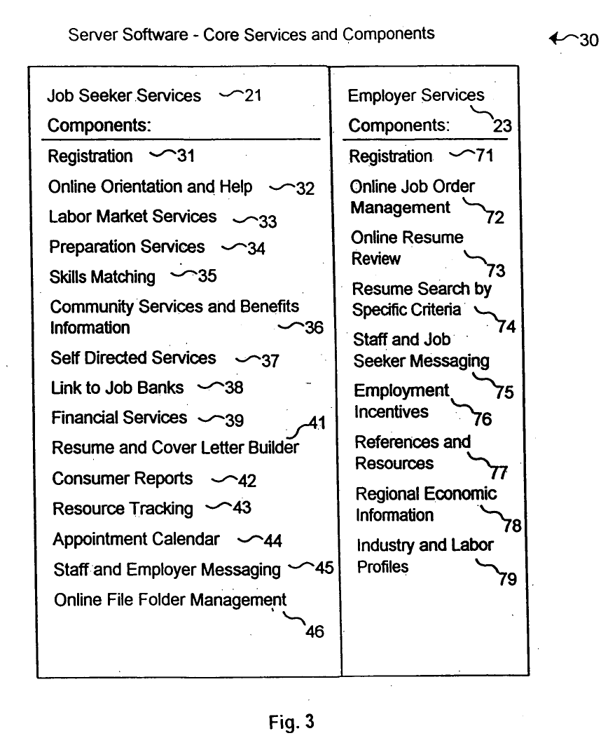

FIG. 4 is the server software comprising intensive and staff-assisted services and a plurality of components.

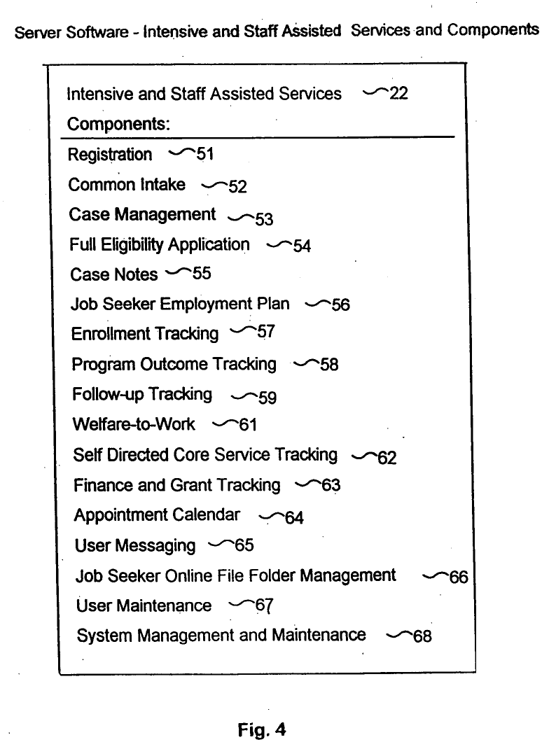

FIG. 5 is the server software comprising additional services and a plurality of components including training provider services and reporting services.

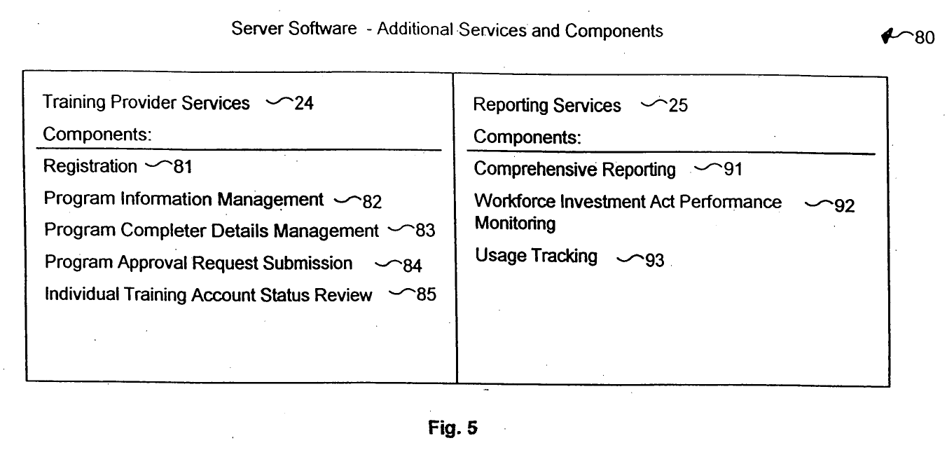

FIG. 6 illustrates a schematic view of a computer system on which the present invention operates.

The same reference numerals refer to the same parts throughout the various Figures.

### DESCRIPTION OF THE PREFERRED EMBODIMENT

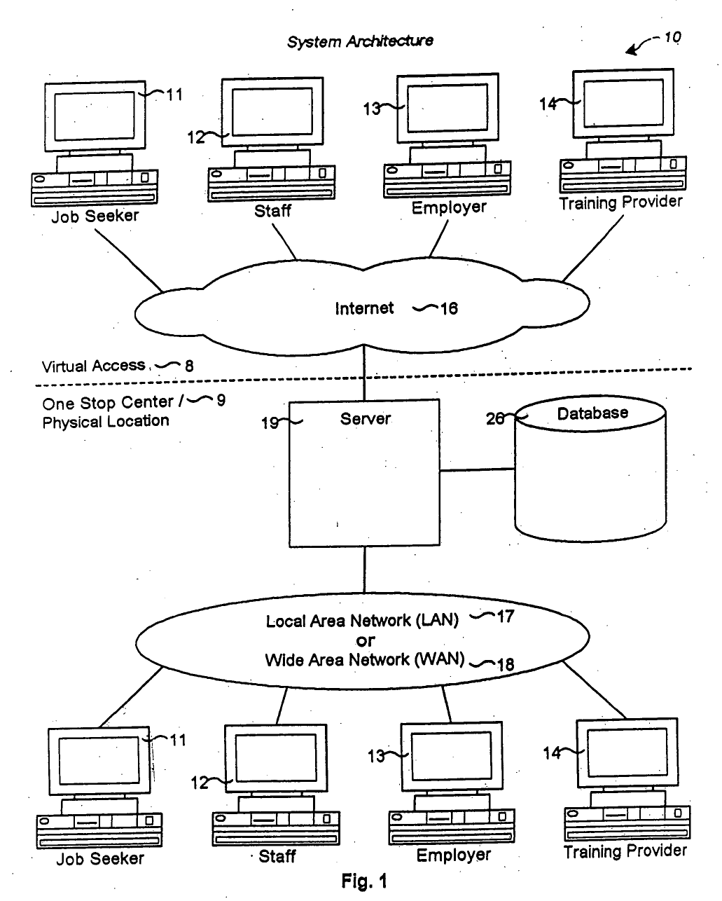

With reference now to the drawings, and in particular to FIG. 1 thereof, the preferred embodiment of the new and improved computerized information system for accessing workforce development services embodying the principles and concepts of the present invention and generally designated by the reference numeral 10 will be described.

The present invention, a computerized information system for accessing workforce development services 10 is comprised of a client 15 operatively couple to a server 19 operatively coupled to a database 26 running a plurality of software components. Such components in their broadest context include core services 30 comprising: a plurality of job seeker services software components 21, a plurality of intensive and staff assisted services software components 22, a plurality of employer services software components 23, and additional services 80 comprising a plurality of training provider services software components 24, and a plurality or reporting services software components 25. Such components are individually configured and correlated with respect to each other so as to attain the desired objective.

A computerized information system for accessing workforce development services by job seekers 11, employers 13, training providers 14, benefit applicants, students, and the like. The system allows staff 12 to manage and maintain 68 the system, providing job seekers 11 with one-stop universal access to self-service and staff-assisted job seeker services 21.

The server has a plurality of core services 30 including job seeker services 21, intensive and staff-assisted services 22, and employer services 23. The job seeker services 21 include a plurality of software components. The job seeker 11 can complete registration 31 independently via virtual access 8, with staff assistance via virtual access 8, or with staff assistance at the physical location 9. The job seeker 11 can access online orientation and help 32 to guide them through the job seeker services 21. The job seeker 11 can create required documents using a resume and cover letter builder 41 in a step-by-step process and store the documents in an online file folder 46. The job seeker 21 can view labor market services 33, access preparation services 34, and analyze their abilities through skills matching 35. The job seeker can view community (or social) services and benefits information 36 and can determine eligibility through a self-service method or with staff assistance. The job seeker 11 can use self directed services 37 to help find jobs and develop job skills and follow links to job banks 38 including America's Job Bank. The job seeker 11 has access to financial services 39 and consumer reports 42. The job seeker 11 can access resource tracking 43 to monitor their use of the system. The job seeker 11 has access to an appointment calendar 44 for interviews, important dates, and other meetings, and a staff and employer messaging 45 facility that for sending, storing and displaying messages on demand.

The intensive and staff assisted services 22 include a plurality of software components. Staff 12 members use these services to provide staff-assisted registration 51 both online via virtual access 8 and at the physical location 9. Staff 12 use common intake 52 to enter new job seekers into the system and accept full eligibility application 54 for any of a range of community services and benefits 36. Staff have access to case management 53 including the ability to assign multiple case managers and write case notes 55. Staff can complete a job seeker employment plan 56. Staff can further view enrollment tracking 57, program outcome tracking 58, follow-up tracking 59, welfare-to-work 61 status, and self directed core service tracking 62. Staff 12 can also view finance and grant tracking 63 for their program. Staff 12 manage job seekers 11 and employers 13 through an automated appointment calendar 64 of interviews, meetings, and other important dates, and have access to user messaging 65 for communicating with job seekers 11, employers 13, and training providers 14, and job seeker online file folder management 66 to view and assist job seekers in managing their resumes, cover letters, and other job-related documents. Staff 12 manage the system through user maintenance 67 for creating and approving user system access, and system management and maintenance 68.

The employer services 23 including a plurality of software components. Employers 12 can complete registration 71, use online job order management 72, online resume review 73 and resume search by specific criteria 74. Employers can communicate with other users and job seeker messaging 75. Employers 12 can view employment incentives 76, references and resources 77, regional economic information 78, and industry and labor profiles 79.

The server also provides a plurality of additional services 80 including training provider services 24 and reporting services 25. The training provider services 24 have a plurality of software components. Training providers 14 can complete registration 81 with staff 12 assistance via virtual access or at a physical location. Training providers 14 can complete program information management 82, and use program completer details management 83 to note job seekers who have successfully completed a program. Training providers 14 can use the program approval request submission 84 to apply for new programs to be included in the system. Training providers 14 can also access individual training account status review 85 to post and view job seeker 11 program completion status.

The reporting services 25 have a plurality of software components for staff 12 use including comprehensive reporting 91 comprising a plurality of job seeker 11, employer 13, and training provider 14 reports. Job seeker 11 reports include system tracking, core service usage, and history reports. Employer 13 reports include job order reports and open referral reports. Workforce Investment Act (WIA) performance monitoring 92 tracks compliance with the WIA program guidelines. The usage tracking 93 summarizes all user access and system activity.

The present invention includes a database 26 of standard format data 29 including America's Labor Market Information System (ALMIS) format and other standard formats, and proprietary format data 39 running stored procedures 27 to manage data. The database 26 is operatively coupled with the server 19 for the two-way communication of information.

The present invention further includes a plurality of input/output client devices 15 such as personal computers operatively coupled with the server 19 for the two-way communication of information. The plurality of client devices allows access from job seekers 11, staff 12, employers 13, and training providers 14 allowing job seekers 11 universal access to self-service and staff-assisted job seeker services 21. The present invention overcomes the problems and disadvantages of the prior art by providing universal access to a broad range of employment, training, and education services. The system ensures that access to, specific services is available to all customers throughout the one-stop system. Anyone with access to the Internet will be able to access the system. The system can provide services to clients who might find it inconvenient to use a physical one-stop due to barriers such as lack of transportation, disability, or other barriers.

To enable broader access to one-stop services, the system can be equipped with interfaces specifically designed for blind or low vision users, Spanish-speaking users, and additional languages as required by the user community.

The present invention is the only system that meets the core and intensive services required under the Workforce Investment Act of 1998 and associated programs such as Welfare to Work and Wagner-Peyser. Services for adults, dislocated workers, youth, and employers are organized and administered as core services and intensive/staff-assisted services.

Labor market information is stored in the ALMIS database structure defined by the U.S. Department of Labor's Employment and Training Administration. As such the system is able to share labor and economic data available from federal, state, and local agencies throughout the United States.

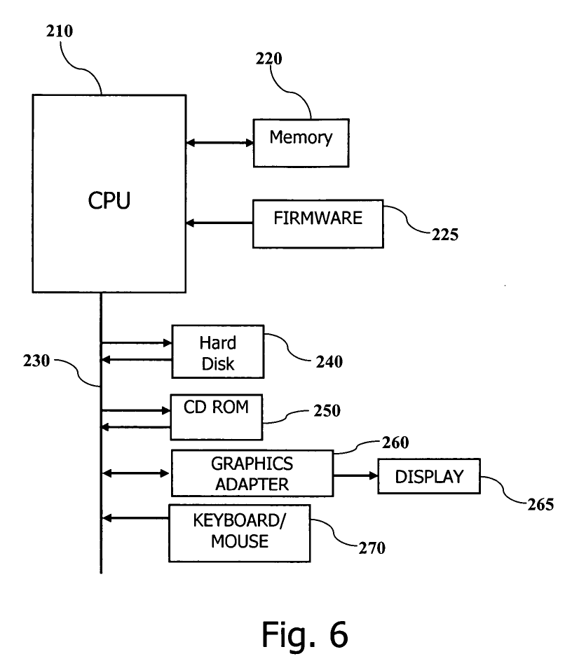

Referring to FIG. 6, a schematic block diagram of a computer-based system of the present invention is shown. In this, a processor 210 is provided to execute stored programs that are generally stored within a memory 220. The processor 210 can be any processor, perhaps an Intel Pentium-4® CPU or the like. The memory 220 is connected to the processor and can be any memory suitable for connection with the selected processor 210, such as SRAM, DRAM, SDRAM, RDRAM, DDR, DDR-2, etc. The firmware 225 is possibly a read-only memory that is connected to the processor 210 and may contain initialization software, sometimes known as BIOS. This initialization software usually operates when power is applied to the system or when the system is reset. Sometimes, the software is read and executed directly from the firmware 225. Alternately, the initialization software may be copied into the memory 220 and executed from the memory 220 to improve performance.

Also connected to the processor 210 is a system bus 230 for connecting to peripheral subsystems such as a hard disk 240, a CDROM 250, a graphics adapter 260, and a keyboard/mouse. 270. The graphics adapter 260 receives commands and display information from the system bus 230 and generates a display image that is displayed on the display 265.

In general, the hard disk 240 may be used to store programs, executable code and data persistently, while the CDROM 250 may be used to load said programs, executable code and data from removable media onto the hard disk 240. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, laser disk, etc. Other devices may be connected to the system through the system bus 230 or with other input-output functions. Examples of these devices include printers; mice; graphics tablets; joysticks; and communications adapters such as modems and Ethernet adapters.

The present invention provides a comprehensive central workforce development system using the latest three-tier system architecture. This structure eliminates the need for field deployment of applications to the user. The only access requirement is an Internet browser. All operations will be performed on the server side.

The present invention establishes an integrated workforce development strategy using a state-of-the-art delivery system providing one-stop functions via the Internet. It provides a total integration of the workforce development services in a way that allows staff and users of different skills and educational levels to use the system. Under current one-stop initiatives, local one-stop systems are envisioned as components of a larger regional, state, and national system. The present invention provides this function in one system since it will be based on a standard structure and integrates directly into systems such as America's Job Bank and America's Labor Market Information System (ALMIS) at the state and federal levels.

The present invention provides a performance-driven outcome-based system that incorporates the performance indicators outlined in the Workforce Investment Act. The system includes the capability to generate sophisticated reports and graphs to evaluate the performance and effectiveness of the workforce system. This includes performance cost and the ability to view user and service tracking data and to generate usage and performance reports and graphs.

The present invention implements an adaptable workforce development solution built from a software component library, permitting the system to be customized to the exact needs of state, regional, and local boards and agencies. The system can also be easily modified to meet changes in business rules and regulations and incorporate enhancements.

The present invention significantly improves one-stop performance and user satisfaction by providing a common core of information and easy access to key services, the system will dramatically increase the quality of service provided by the boards and agencies. The result will be a significant increase in placement opportunities along with more positive placements. The system's easy and effective mechanisms will connect a larger pool of job seekers, employers, providers, and students; and deliver overall improved one-stop performance.

The present invention significantly improves one-stop service and use by serving a significant number of users via an easy-to-use interface. The system allows case managers and counselors to spend more time with clients and deliver improved service to users requiring more intensive services. The system effectively bridges the gap between job opportunities and the pool of workers qualified to fill them.

The present invention provides unlimited use as an Internet/intranet solution. There is no limit to the number of users who can access the system. Any authorized users, provided they have Internet access, can access the system from any location, or from a computer at the physical location of the one-stop center.

The present invention establishes an open and non-proprietary database where possible using existing state and federal database standards. The system accesses data stored in the America's Labor Market Information System (ALMIS) database structure defined by the U.S. Department of Labor's Employment and Training Administration. Any organization using the system can share the wealth of labor and economic data available from federal, state, and local agencies throughout the United States.

The present invention improves user choice by giving users options critical to a one-stop operating system. Employers and job seekers will have choices in how and where they can obtain information and services and will have access to the information needed to make informed choices about education and training.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to been encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A system for workforce development,4using a network, the system comprising:
a server operably coupled to the network, the server accessing at least one standardized format database containing labor market information and at least one proprietary format database; and
at least one client operably coupled to the network and in communication with the server;
whereas the client is configured to request job seeker services together with employment services through the server and the server is configured to access at least one of the at least one standard format database and the at least one proprietary format database and the server is further configured to obtain the requested job seeker services and together with employer services and thereafter respond to the client.

2. The system for workforce development according to claim 1, wherein one of the at least one standardized format database complies with the America's Labor Market Information System.

3. The system for workforce development according to claim 1, wherein the job seeker services are selected from the group consisting of registration; online orientation and help; labor market service; preparation services; skills matching; community services and benefits; self directed services; links to job banks; financial services; resume and cover letter builders; consumer reports; resource tracking; appointment calendar; staff and employer messaging; and online file folder management.

4. The system for workforce development according to claim 1, wherein the employment services are employer related services.

5. The system for workforce development according to claim 4, wherein the employer related services are selected from the group consisting of registration; online job order management; online resume review; resume search by specific criteria; staff and job seeker messaging; employment incentive management; references and resources; regional economic information; and industry and labor profiles.

6. The system for workforce development according to claim 1, wherein the employment services are staff assisted services provided by one of the at least one clients.

7. The system for workforce development according to claim 6, wherein the staff assisted services are selected from the group consisting of registration; common intake; case management; full eligibility application; case notes; job seeker employment planning; enrollment tracking; program outcome tracking; follow-up tracking; welfare-to-work management; self directed core service tracking; finance and grant tracking; appointment calendar; user messaging; job seeker online file folder management; user maintenance and system management and maintenance.

8. A system for workforce development using a network, the system comprising:
a server operably coupled to the network, the server having a means to access at least one standardized format database containing labor market information; the server having a means to access at least one proprietary format database; the server further having a means to access job seeker services; and
at least two clients operably coupled to the network and in communication with the server, the at least two clients comprising a first client and a second client, the first client adapted to request the job seeker services together with staff-assisted services; the second client providing the staff-assisted services;
whereas the server is configured to operatively connect the first client to the second client to fulfill the staff-assisted services.

9. The system for workforce development according to claim 8, wherein one of the at least one standardized format database complies with the America's Labor Market Information System.

10. The system for workforce development according to claim 8, wherein the staff assisted services are selected from the group consisting of registration; online orientation and help; labor market service; preparation services; skills matching; community services and benefits; self directed services; links to job banks; financial services; resume and cover letter builders; consumer reports; resource tracking; appointment calendar; staff and employer messaging; and online file folder management.

11. The system for workforce development according to claim 8, wherein the job seeker services are selected from the group consisting of registration; online orientation and help; labor market service; preparation services; skills matching; community services and benefits; self directed services; links to job banks; financial services; resume and cover letter builders; consumer reports; resource tracking; appointment calendar; staff and employer messaging; and online file folder management.

12. A system for workforce development using a network, the system comprising:
a computer readable medium;
a computer program encoded on the computer readable medium, the computer program operable to be executed by a computer system, the computer program further operable to:
receive requests for job seeker services together with employment services from at least one client through the network;
access at least one standardized format database containing labor market information and at least one proprietary format database;
obtain the job seeker services together with employment services; and
respond to the client with the requested job seeker services and the employment services.

13. The system for workforce development according to claim 12, wherein one of the at least one standardized format database complies with the America's Labor Market Information System.

14. The system for workforce development according to claim 12, wherein the job seeker services are selected from the group consisting of registration; online orientation and help; labor market service; preparation services; skills matching; community services and benefits; self directed services; links to job banks; financial services; resume and cover letter builders; consumer reports; resource tracking; appointment calendar; staff and employer messaging; and online file folder management.

15. The system for workforce development according to claim 12, wherein the employment services are employer related services.

16. The system for workforce development according to claim 14, wherein the employer related services are selected from the group consisting of registration; online job order management; online resume review; resume search by specific criteria; staff and job seeker messaging; employment incentive management; references and resources; regional economic information; and industry and labor profiles.

17. The system for workforce development according to claim 12, wherein the employment services are staff assisted services provided by one of the at least one clients.

18. The system for workforce development according to claim 17, wherein the staff assisted services are selected from the group consisting of registration; common intake; case management; full eligibility application; case notes; job seeker employment planning; enrollment tracking; program outcome tracking; follow-up tracking; welfare-to-work management; self directed core service tracking; finance and grant tracking; appointment calendar; user messaging; job seeker online file folder management; user maintenance and system management and maintenance.

19. A system for workforce development using a network, the system comprising:
a computer readable medium;
at least two clients operably coupled to the network and in communication with the server, the at least two clients comprising a first client and a second client, the first client adapted to request job seeker services together with staff-assisted services; the second client providing the staff-assisted services;
a computer program encoded on the computer readable medium, the computer program operable to be executed by a computer system, the computer program further operable to:
receive the requests for the job seeker services and the staff-assisted services from the first client;
access at least one standardized format database containing labor market information and access the at least one proprietary format database to provide the job seeker services; and
connecting the first client to the second client, whereby the second client provides the staff-assisted services.

20. The system for workforce development according to claim 19, wherein one of the at least one standardized format database complies with the America's Labor Market Information System.

21. The system for workforce development according to claim 19, wherein the staff assisted services are selected from the group consisting of registration; online orientation and help; labor market service; preparation services; skills matching; community services and benefits; self directed services; links to job banks; financial services; resume and cover letter builders; consumer reports; resource tracking; appointment calendar; staff and employer messaging; and online file folder management.

22. The system for workforce development according to claim 19, wherein the job seeker services are selected from the group consisting of registration; online orientation and help; labor market service; preparation services; skills matching; community services and benefits; self directed services; links to job banks; financial services; resume and cover letter builders; consumer reports; resource tracking; appointment calendar; staff and employer messaging; and online file folder management.
